(19) United States
(12) Patent Application Publication
(10) Pub. No.: US 2010/0258359 A1
(43) Pub. Date: Oct. 14, 2010

(54) PORTABLE ELECTRONIC WRITING PAD

(76) Inventors: Jacob Ari Stein, Morristown, NJ (US); Steven Bruce Stein, Morristown, NJ (US)

Correspondence Address: STEVEN B. STEIN, 114 OLD BLOOMFIELD AVENUE, PARSIPPANY, NJ, 07054, US

(21) Appl. No.: 12/760,446

(22) Filed: Apr. 14, 2010

Related U.S. Application Data
(60) Provisional application No. 61/169,183, filed on Apr. 14, 2009.

(51) Int. Cl. G08C 21/00; H04B 7/00

(52) U.S. Cl. 178/18.03; 455/41.2

(57) ABSTRACT

The present invention provides a writing pad device, comprising (a) a writing pad device base having a front writing surface; a plurality of writing pad device wireless signal receivers; a plurality of wireless writing pad device transmitters; a power source; and (b) a writing implement device, comprising a writing implement body having a top end portion central body portion a bottom end; a conventional writing tip capable of transferring physical material to a surface, wherein the conventional writing tip is positioned at the most terminal portion of the bottom end of the writing implement; a wireless writing tip transmitter capable of transmitting a wireless signal, positioned at the bottom end of the writing implement device, closely positioned to the conventional writing tip; a writing implement transmitter power source; and at least one activation switch, capable of controlling power to the transmitter.

The present invention claims priority to Provisional Patent Application No. 61/169,183, filed Apr. 14, 2009, which is hereby incorporated in its entirety.

### FIELD OF THE INVENTION

The present invention relates generally to an electronic writing device. More specifically, the invention relates to a portable electronic writing pad device and electronic writing implement capable of writing on conventional paper and contemporaneously transmitting the written data to an electronic storage or electronic display device such as a computer.

### BACKGROUND OF THE INVENTION

In today's fast paced world, professionals continue to use convention pads and paper for recording notes, data, medical patient charts, sales information, inventories, marketing data, and correspondence, despite the availability of electronic so-called “time-saving” and “paper saving” devices. The pervasive use of convention materials has led to duplication and transcription errors, which can often have serious consequences. For example, in medical applications, an increasing number of institutions are encouraging the use of personal digital assistants (PDAs) or hand-held computers for the storage and transmission of patient data to centralized databases. While the goal may be to eliminate the often difficult to decipher handwriting on a convention written medical chart, the reality is that medical charts that remain at a patient's bedside and that are updated in real time continue to be a preferred means of relaying patient data in a proximate and immediate way. Unfortunately, transcription errors continue to pose serious threats to patient health. On the other hand, the central storage of patient data confers significant benefits, making patient specific information available to all of a patient's treating professional, even at great distance. Accordingly, there is a need to be able to preserve and facilitate both the conventional manual system (proximate and immediate) as well as the modern system (electronic, centrally stored, remotely accessible).

The present invention solves this need by providing a device capable of contemporaneously storing data in both electronic and conventional forms to both electronic storage devices and conventional (i.e. paper) ones, all in a portable system.

### SUMMARY OF THE INVENTION

It is therefore an object of the present invention to provide a portable electronic writing pad device and electronic writing implement capable of writing on conventional paper and contemporaneously transmitting the written data to an electronic storage or electronic display device such as a computer.

According to a preferred embodiment of the invention, the writing implement comprises a wireless transmission element such as a radio frequency identification transmitter (RFID), infrared transmitter (IR) or a blue tooth transmitter (BT). According to a preferred embodiment of the invention, the writing pad device comprises a plurality of receiver elements capable of receiving a transmission from a writing implement transmitter. According to a preferred embodiment, a writing implement IR transmitter would be received by a writing pad IR receiver. According to an embodiment of this invention, the writing pad device further comprises at least one wireless transmission element such as a radio frequency identification transmitter (RFID), infrared transmitter (IR) or a blue tooth transmitter (BT). According to an alternative embodiment, the writing pad device comprises at least one non-wireless transmission element. According to another embodiment the invention further comprises an electronic storage device, capable of receiving transmissions from the writing pad device. According to still a further embodiment, the invention further comprises software capable of directing the display of the position of the writing element transmitting device. According to a most preferred embodiment of the invention, the writing implement further comprises a convention writing tip, such as for use with ink or graphite, capable of writing to convention surfaces such as paper.

The prior art describes electronic writing devices. Touch-sensitive devices are also well known in the prior art. The present invention purports to have solved the present problem in the art of portability and remote data storage and display.

### BRIEF DESCRIPTION OF THE DRAWINGS

For a fuller understanding of the nature and desired objects of the present embodiments, reference is made to the following detailed description taken in conjunction with the accompanying figures, wherein like reference characters denote corresponding parts throughout the views, and in which:

FIG. 1 shows a front prospective view of an exemplary embodiment of the writing pad device.

FIG. 2 shows a front view of an exemplary embodiment of the writing implement.

### DETAILED DESCRIPTION

A writing pad device, comprising (a) a writing pad device base having (i) a top end, a bottom end, a left side, a right side, an front writing surface and a back surface; (ii) a plurality of writing pad device wireless signal receivers; (b) a plurality of wireless writing pad device transmitters; (c) a power source; and (d) a writing implement device, wherein the writing implement device further comprises: (i) a writing implement body having a top end portion central body portion a bottom end; (ii) a conventional writing tip capable of transferring physical material to a surface, wherein the conventional writing tip is positioned at the most terminal portion of the bottom end of the writing implement; (iii) a wireless writing tip transmitter capable of transmitting a wireless signal, positioned at the bottom end of the writing implement device, closely positioned to the conventional writing tip; (iv) a writing implement transmitter power source; and (v) at least one activation switch, capable of controlling power to the transmitter.

According to a preferred embodiment, the writing pad device comprises at least four infrared (IR) receivers, positioned approximately at each case of the four corners of the writing surface of the device. According to an alternative embodiment, the receivers are slightly elevated above the surface of the writing pad device in order to improve the angle of reception of an IR signal from the writing implement device. According to a preferred embodiment of this invention, the writing implement device comprises an infrared (IR) transmitter element, capable of transmitting a signal to one or more of the IR receivers positioned on the writing pad device. It is specifically contemplated by the invention that alternative transmitter/receiver components can be substituted, such as RFID, BT, and the like, which are well known in the art. According to the preferred embodiment, the writing pad device further comprising at least four blue tooth (BT) transmitters, positioned approximately at each of the four corners of the writing surface of the device. According to an alternative embodiment, the transmitters are slightly elevated above the surface of the writing pad device in order to improve the angle of transmission of a BT signal from the writing pad device. According to an alternative embodiment, the writing pad device transmitter (BT) and the writing pad device receiver (IR) are combined into a single component. It is specifically contemplated by the invention that alternative transmitter/receiver components can be substituted, such as RFID, BT, and the like, which are well known in the art. According to a preferred embodiment of this invention, the writing pad device further comprises a power source, suitable for providing the power requirement for each transmitter/receiver component. According to a most preferred embodiment of the invention, the power source is a battery. According to a preferred embodiment, the writing implement device further comprises a power source capable of providing the power requirement for the writing implement device transmitter. According to still another preferred embodiment, the writing implement device further comprises an ink reservoir. According to an alternative embodiment, the writing implement device further comprises a graphite reservoir.

It is contemplated by the present invention that a computer software program is utilized to compute as storable data, the position of the writing implement device transmitter relative to one or more of the writing pad device receivers, thereby translating the relative position of the writing implement device on the writing pad device. It is further understood that the computer software program is utilized contemporaneously display the position of the writing implement device in near real-time. It is still further contemplated by the present invention that the computer software program is utilized to direct the storage of the data on an electronic storage device such as a computer hard drive. Inclusion of a computer is specifically contemplated.

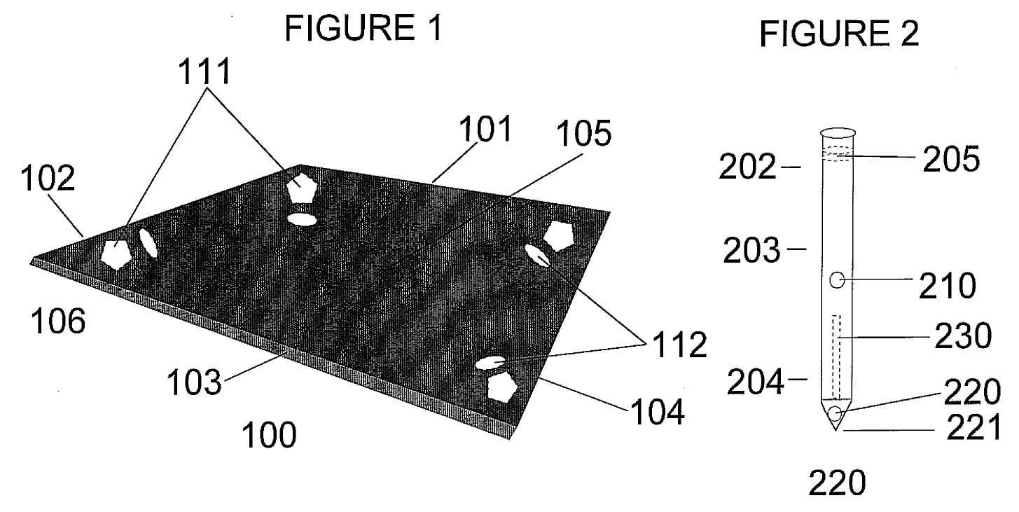

Turning now to the drawings. FIG. 1 shows a front prospective view of an exemplary embodiment of the writing pad device 100. The writing pad device 100, comprises (a) a writing pad device base having (i) a top end 101, a bottom end 103, a left side 102, a right side 104, an front writing surface 105 and a back surface 106; (ii) a plurality of writing pad device wireless signal receivers 111; (b) a plurality of wireless writing pad device transmitters 112 and (a) a power source.

FIG. 2 shows a front view of an exemplary embodiment of the writing implement device 200, wherein the writing implement device 200 further comprises: (i) a writing implement body 201 having a top end portion 202 central body portion 203 a bottom end 204; (ii) a conventional writing tip 221 capable of transferring physical material to a surface, wherein the conventional writing tip is positioned at the most terminal portion of the bottom end of the writing implement; (iii) a wireless writing tip transmitter 220 capable of transmitting a wireless signal, positioned at the bottom end of the writing implement device, closely positioned to the conventional writing tip; (iv) a writing implement transmitter power source 205; and (v) at least one activation switch 210, capable of controlling power to the transmitter. According to a preferred embodiment, the writing implement device further comprises an ink reservoir 230 connected to the writing tip 221.

This invention may be embodied in other forms or carried out in other ways without departing from the spirit or essential characteristics thereof. The present disclosure is therefore to be considered as in all respects illustrative and not restrictive, the scope of the invention being indicated by the appended Claims, and all changes which come within the meaning and range of equivalency are intended to be embraced therein. Further, any document(s) mentioned herein are incorporated by reference in their entirety, as are any other documents that are referenced within such document(s).

We claim:

1. A writing pad device, comprising (a) a writing pad device base having (i) a top end, a bottom end, a left side, a right side, a front writing surface and a back surface; (ii) a plurality of writing pad device wireless signal receivers; (b) a plurality of wireless writing pad device transmitters; (c) a power source; and (d) a writing implement device, wherein the writing implement device further comprises: (i) a writing implement body having a top end portion central body portion a bottom end; (ii) a conventional writing tip capable of transferring physical material to a surface, wherein the conventional writing tip is positioned at the most terminal portion of the bottom end of the writing implement; (iii) a wireless writing tip transmitter capable of transmitting a wireless signal, positioned at the bottom end of the writing implement device, closely positioned to the conventional writing tip; (iv) a writing implement transmitter power source; and (v) at least one activation switch, capable of controlling power to the transmitter.

2. The writing pad device according to claim 1, wherein the writing pad device wireless signal receivers are infrared (IR) receivers.

3. The writing pad device according to claim 1, wherein the plurality of writing pad device wireless receivers is comprising at least four infrared (IR) receivers, positioned approximately at each of the four corners of the writing surface of the device.

4. The writing pad device according to claim 1, wherein the writing pad device wireless receivers are slightly elevated above the surface of the writing pad device in order to improve the angle of reception of an IR signal from the writing implement device.

5. The writing pad device according to claim 1, wherein the writing implement device comprises an infrared (IR) transmitter element, capable of transmitting a signal to one or more of the IR receivers positioned on the writing pad device.

6. The writing pad device according to claim 1, wherein the transmitter is a RFID device.

7. The writing pad device according to claim 1, wherein the transmitter is a blue tooth device.

8. The writing pad device according to claim 1, wherein the receiver is a RFID device.

9. The writing pad device according to claim 1, wherein the receiver is a blue tooth device.

10. The writing pad device according to claim 1, wherein the writing pad device comprises four blue tooth (BT) transmitters, positioned approximately at each of the four corners of the writing surface of the device.

11. The writing pad device according to claim 1, wherein the transmitters are slightly elevated above the surface of the writing pad device in order to improve the angle of transmission of a BT signal from the writing pad device.

12. The writing pad device according to claim 1, wherein the writing pad device transmitter (BT) and the writing pad device receiver (IR) are combined into a single component.

13. The writing pad device according to claim 1, further comprising a power source, suitable for providing the power requirement for each transmitter and receiver component.

14. The writing pad device according to claim 12, wherein the power source is a battery.

15. The writing pad device according to claim 12, wherein the writing implement device further comprises a power source capable of providing the power requirement for the writing implement device transmitter.

16. The writing pad device according to claim 1, wherein the writing implement device further comprises an ink reservoir.

17. The writing pad device according to claim 1, wherein the writing implement device further comprises a graphite reservoir.

18. The writing pad device according to claim 1, further comprising a computer software program to compute as storable data, the position of the writing implement device transmitter relative to one or more of the writing pad device receivers, thereby translating the relative position of the writing implement device on the writing pad device.

19. The writing pad device according to claim 18, wherein the computer software program is facilitates contemporaneously display on a computer of the position of the writing implement device in near real-time.

20. The writing pad device according to claim 16, wherein the computer software program is capable of directing storage of the storable data on an electronic storage device such as a computer hard drive.
